(19) United States
(12) Patent Application Publication
(10) Pub. No.: US 2026/0279174 A1
(43) Pub. Date: Sep. 17, 2026

(54) EMERGENCY EVACUATION METHODS AND SYSTEMS FOR SMART CITY HIGH-RISE BUILDING FIRES BASED ON AN INTERNET OF THINGS (IOT) LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Xing SHU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/673,987

(22) Filed: May 11, 2026

(30) Foreign Application Priority Data
Feb. 14, 2026 (CN) 202610214800.6

(51) Int. Cl. G08B 7/06; G05D 1/69; G05D 105/55; G05D 105/80; G05D 107/40; G05D 109/10; G05D 111/30; G05D 111/50; G08B 21/02; G16Y 40/10

(52) U.S. Cl. CPC G08B 7/066; G05D 1/69; G08B 21/02; G16Y 40/10; G05D 2105/55; G05D 2105/80; G05D 2107/40; G05D 2109/10; G05D 2111/32; G05D 2111/56

(57) ABSTRACT

Disclosed is an emergency evacuation system for smart city high-rise building fire based on an Internet of Things (IoT) large model, comprising: an emergency supervision and management platform configured to: monitor an environmental parameter of each of one or more geographic regions; identify a fire risk region from the one or more geographic regions; determine a first emergency kit and an evacuation route for evacuating from a building, send an early warning notice to user terminals; control a first emergency robot to move along the evacuation route and send a guidance signal to a user; in response to presence of a fire, identify safety regions from the one or more geographic regions, and send the safety regions to a user terminal; determine a second emergency kit and a temporary evacuation route; control a second emergency robot to move toward a nearest safety region, and send the guidance signal to the user.

### CROSS-REFERENCE TO RELATED APPLICATIONS

This application claims priority to Chinese Application No. 202610214800.6, filed on Feb. 14, 2026, the entire contents of which are incorporated herein by reference.

### TECHNICAL FIELD

The present disclosure relates to the field of urban fire safety monitoring, in particular to an emergency evacuation system and method for smart city high-rise building fire based on an Internet of Things (IoT) large model.

### BACKGROUND

With the acceleration of urbanization, high-rise buildings pose severe challenges to traditional fire emergency systems due to long vertical evacuation routes and high population density. At present, the mainstream fixed fire alarm systems and static evacuation plans have significant shortcomings. Deployment of a single sensor leads to frequent false alarms and difficulty in assessing fire situations. Preset fixed escape routes may not be dynamically adjusted according to changes in the fire situation. Manual scheduling modes cause lag in the response speed of emergency resources.

Therefore, it is desirable to provide an emergency evacuation method and system for smart city high-rise building fire based on an IoT large model to achieve precise monitoring and early warning of fire risks in urban high-rise buildings, and improve the effectiveness and timeliness of emergency evacuation in urban high-rise building fire.

### SUMMARY

One or more embodiments of the present disclosure provide an emergency evacuation system for smart city high-rise building fire based on an IoT large model. The emergency evacuation system includes an emergency supervision and management platform. The emergency supervision and management platform includes a processor and a database. The emergency supervision and management platform is configured to execute an emergency evacuation method for smart city high-rise building fire based on an IoT large model.

One or more embodiments of the present disclosure provide an emergency evacuation method for smart city high-rise building fire based on an IoT large model. The emergency evacuation method includes: monitoring an environmental parameter of each of one or more geographic regions through a multimodal sensor group, the multimodal sensor group including at least one of a smoke sensor, a temperature sensor, and an oxygen sensor; identifying a fire risk region from the one or more geographic regions based on the environmental parameter and building information modeling (BIM) data through the processor; determining a first emergency kit and an evacuation route for evacuating from a building based on the fire risk region by retrieving the database, controlling the first emergency kit to automatically open an airtight door and release a first emergency robot, and sending an early warning notice to user terminals in the fire risk region and an adjacent geographic region; controlling the first emergency robot to move along the evacuation route via a wireless network and send a guidance signal to a user; in response to presence of a fire, identifying safety regions within the building from the one or more geographic regions through the processor, and sending the safety regions to a user terminal on a designated floor via the wireless network; determining a second emergency kit and a temporary evacuation route based on a distribution of the safety regions, and controlling the second emergency kit to automatically open another airtight door and release a second emergency robot; controlling the second emergency robot to move toward a nearest safety region along the temporary evacuation route via the wireless network, and sending the guidance signal to the user.

One or more embodiments of the present disclosure provide a non-transitory computer-readable storage medium, including computer instructions that, when read by a computer, direct the computer to execute an emergency evacuation method for smart city high-rise building fire based on an IoT large model.

### BRIEF DESCRIPTION OF THE DRAWINGS

The present disclosure is further described in an exemplary manner by embodiments, which are described in detail with reference to the accompanying drawings. These embodiments are not limiting. In these embodiments, the same numbers refer to the same structures, wherein:

FIG. 1 is a schematic structural diagram illustrating an emergency evacuation system for smart city high-rise building fire based on an IoT large model according to some embodiments of the present disclosure;

FIG. 2 is a flowchart illustrating an exemplary emergency evacuation method for smart city high-rise building fire based on an IoT large model according to some embodiments of the present disclosure;

FIG. 3 is a schematic structural diagram illustrating a fire spread model according to some embodiments of the present disclosure;

FIG. 4 is a flowchart illustrating an exemplary method for determining a fire risk region according to some embodiments of the present disclosure;

FIG. 5 is a schematic diagram illustrating an exemplary display of a three-dimensional dynamic model according to some embodiments of the present disclosure.

### DETAILED DESCRIPTION

To more clearly illustrate the technical solutions of the embodiments of the present disclosure, the following briefly introduces the accompanying drawings required for describing the embodiments. Obviously, the accompanying drawings in the following description are merely some examples or embodiments of the present disclosure. For those having ordinary skills in the art, without creative efforts, the present disclosure may be applied to other similar scenarios based on these accompanying drawings. Unless obviously obtained from the context or the context illustrates otherwise, the same numeral in the drawings refers to the same structure or operation.

It should be understood that the terms “system”, “device”, “unit” and/or “module” used herein are a method for distinguishing components, elements, parts, sections or assemblies of different levels. However, if other words may achieve the same purpose, the words may be replaced by other expressions.

The present disclosure uses flowcharts to illustrate operations performed by the system according to the embodiments of the present disclosure. It should be understood that the preceding or following operations are not necessarily performed precisely in sequence. Conversely, the steps may be processed in reverse order or simultaneously. Meanwhile, other operations may be added to these processes, or one or more steps may be removed from these processes.

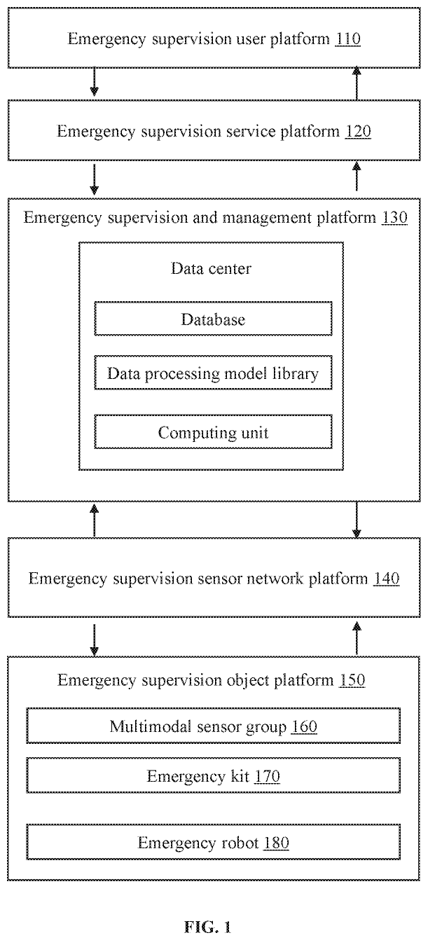

FIG. 1 is a schematic structural diagram illustrating an emergency evacuation system for smart city high-rise building fire based on an IoT large model according to some embodiments of the present disclosure.

In some embodiments, an emergency evacuation system (hereinafter referred to as the system) 100 for smart city high-rise building fire based on an IoT large model may include an emergency supervision user platform 110, an emergency supervision service platform 120, an emergency supervision and management platform 130, an emergency supervision sensor network platform 140, an emergency supervision object platform 150, a multimodal sensor group 160, an emergency kit 170, and an emergency robot 180. The IoT large model refers to an IoT model architecture for achieving efficient operation of a large amount of data in the system 100. In some embodiments, an artificial intelligence (AI) model (e.g., ChatGPT, Gemini, and DeepSeek) may be applied to the IoT model architecture for data perception and processing.

In some embodiments, the multimodal sensor group 160, the emergency kit 170, and the emergency robot 180 are disposed in the emergency supervision object platform 150.

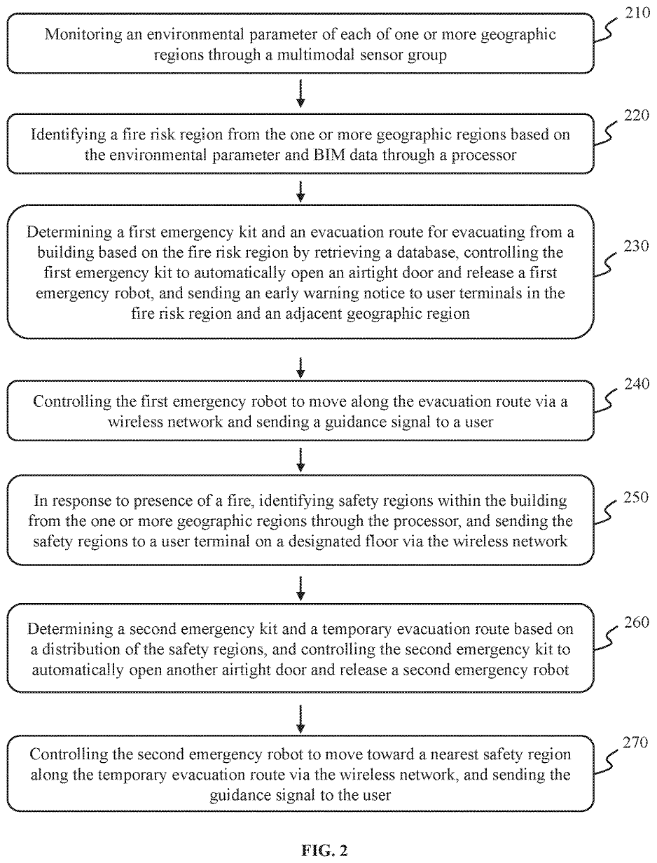

The emergency supervision user platform 110 refers to an interactive platform for emergency management personnel and users. In some embodiments, the emergency supervision user platform 110 may include a processor, a server, a gateway, a display screen, or the like. In some embodiments, the emergency supervision user platform 110 may be in communication connection to a user terminal (e.g., a mobile phone, a computer, a personal digital assistant, etc.). The emergency supervision user platform 110 may communicate and transmit data with the user terminal based on an instruction sent by the emergency supervision and management platform 130. For example, the emergency supervision user platform 110 may display a fire risk region, a potential risk region, a safety region, etc. to the user terminal; the emergency supervision user platform 110 may receive location information sent by the user terminal, etc. More descriptions regarding the fire risk region, the potential risk region, and the safety region may be found in FIG. 2 and the related descriptions thereof.

The emergency supervision service platform 120 refers to a platform providing emergency supervision services. In some embodiments, the emergency supervision service platform 120 may be configured as a server for bidirectional data interaction with the emergency supervision user platform 110 and the emergency supervision and management platform 130.

The emergency supervision and management platform 130 refers to a platform for supervising and managing information related to urban high-rise building fire. In some embodiments, the emergency supervision and management platform 130 may include a server, a data storage system, a large-screen display system, IoT platform software, a communication component (e.g., a communication interface, and a gateway), etc. In some embodiments, the emergency supervision and management platform 130 may be a software platform running on a server or in the cloud and configured to process data and/or information obtained from other platforms (e.g., the emergency supervision service platform 120 and the emergency supervision sensor network platform 140). The emergency supervision and management platform 130 may execute program instructions based on the obtained data, information, and/or corresponding processing results to perform the functions and/or steps described in the present disclosure.

In some embodiments, the emergency supervision and management platform 130 may include a data center. The data center includes a database, a data processing model library, and a computing unit.

The database is configured to collect, store, and manage data related to emergency evacuation in the high-rise building fire. For example, the data includes BIM data, data (e.g., a temperature, a smoke concentration, and an oxygen concentration) monitored and collected by sensors, etc. The database may include MySQL, PostgreSQL, InfluxDB, Prometheus, etc. More descriptions regarding the BIM data and the data monitored and collected by the sensors may be found in FIG. 2 and the related descriptions thereof.

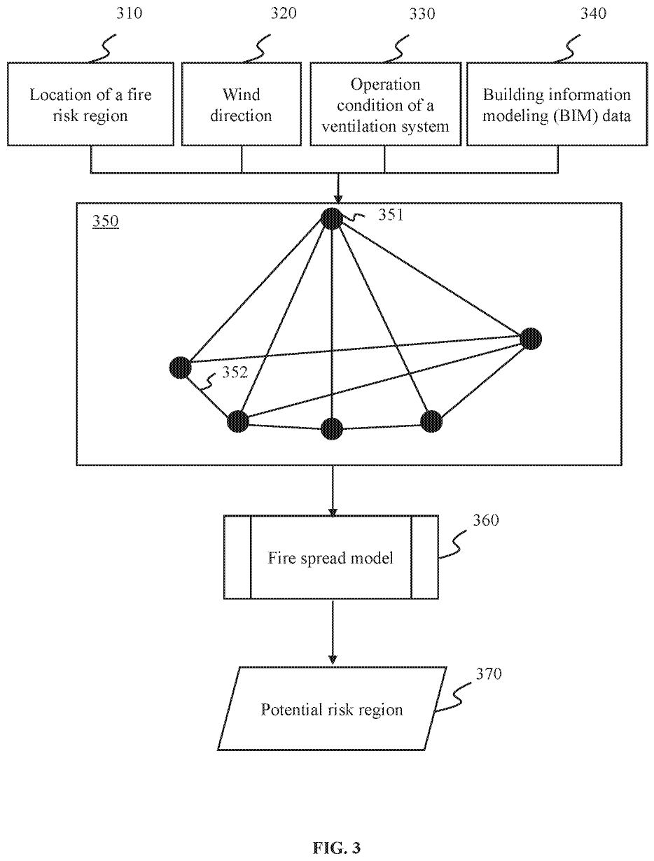

The data processing model library is configured to store a trained data processing large model. In some embodiments, the data processing model library may include a chatbot, a fire spread model, etc. More descriptions regarding the fire spread model may be found in FIG. 3 and the related descriptions thereof.

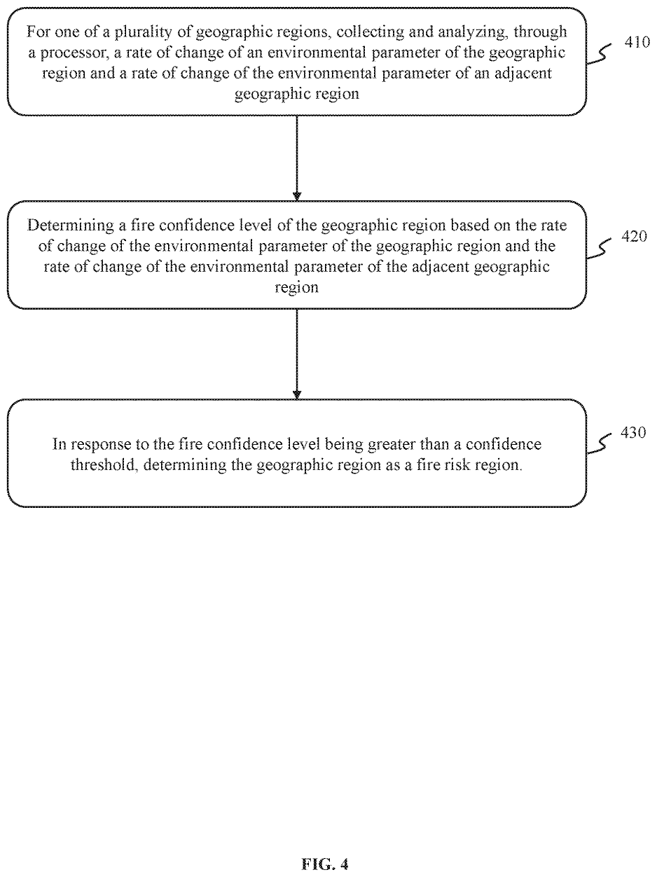

The computing unit refers to a functional module that performs arithmetic, logic, and other instruction operations. The computing unit may include a processor. The processor may include a central processing unit (CPU), a graphics processing unit (GPU), a field-programmable gate array (FPGA), an application specific integrated circuit (ASIC), an application specific instruction set processor (ASIP), etc. In some embodiments, the processor may be configured for algorithm operation, data processing, and sending control signals. For example, the processor may identify a fire risk region, determine a release time of an emergency robot, or the like. More descriptions regarding identification of the fire risk region and the release time of the emergency robot may be found in FIG. 2, FIG. 4, and the related descriptions thereof.

The emergency supervision sensor network platform 140 refers to a platform for comprehensive management of sensing information of smart city high-rise building fire. In some embodiments, the emergency supervision sensor network platform 140 may include a processor, a server, a gateway, or the like. In some embodiments, the emergency supervision sensor network platform 140 may perform bidirectional data interaction with the emergency supervision and management platform 130 and the emergency supervision object platform 150. In some embodiments, the emergency supervision sensor network platform 140 may control operation of the multimodal sensor group 160. For example, the emergency supervision sensor network platform 140 may adjust a frequency at which the multimodal sensor group 160 monitors and collects sensing data.

The emergency supervision object platform 150 refers to a platform for supervised entities or systems, and is configured to display, manage, and analyze operation conditions and data of the supervised entities or systems. In some embodiments, the emergency supervision object platform 150 may include a processor, a server, a gateway, or the like. In some embodiments, the emergency supervision object platform 150 may be configured to supervise the multimodal sensor group 160, the emergency kit 170, and the emergency robot 180 disposed thereon. For example, the emergency supervision object platform 150 may be in communication connection to the emergency kit 170 and the emergency robot 180 to achieve bidirectional data interaction. The emergency supervision object platform 150 may receive an instruction from the emergency supervision and management platform 130 through the emergency supervision sensor network platform 140, control, based on the instruction, the emergency kit 170 to open to release the emergency robot 180, and control operation of the emergency robot 180. For example, the emergency supervision object platform 150 may adjust a moving speed of the emergency robot 180, a flashing frequency of an indicator light of the emergency robot 180, etc.

The multimodal sensor group 160 is a collection of a plurality of types of sensors. In some embodiments, the multimodal sensor group 160 may include a smoke sensor, a temperature sensor, an oxygen sensor, a thermal imaging sensor, a toxic gas sensor, a miniature wind speed and direction sensor, etc. The sensor may periodically send a heartbeat packet to the emergency supervision sensor network platform 140, indicating that the sensor is still functioning properly and connected to a network. If the emergency supervision sensor network platform 140 does not receive the heartbeat packet from the sensor within a preset time period (e.g., 30 min), the emergency supervision sensor network platform 140 may mark the sensor as a failed sensor. When uploading data, the sensor may attach verification information. If the verification information indicates that the data is corrupted or lost during transmission, the emergency supervision sensor network platform 140 may request the sensor to retransmit the data. In a geographic region (e.g., a computer room) requiring key monitoring, the system 100 may deploy a plurality of sensors of the same type to achieve backup of the sensors and sensing data. More descriptions regarding the multimodal sensor group 160 and the geographic region may be found in FIG. 2 and the related descriptions thereof.

The emergency kit 170 refers to an intelligent storage device provided on the emergency supervision object platform 150. In some embodiments, the emergency kit 170 is configured to store the emergency robot or other rescue equipment (e.g., a window breaker, a fire extinguisher, etc.). The emergency robot 180 refers to a robot configured to perform tasks such as rescue, environmental detection, and evacuation guidance. In some embodiments, the emergency robot 180 may include a reconnaissance robot, a fire-fighting robot, and a guidance robot. The reconnaissance robot is configured to determine a location and a scope of a fire, and is capable of performing detection at an edge of the fire risk region. The fire-fighting robot has a function of automatically spraying a fire extinguishing agent or cooling, and is configured to perform local control when a fire spreads, creating conditions for personnel evacuation or firefighter entry. The guidance robot is configured to guide crowd evacuation. For example, the guidance robot may provide clear navigation for evacuation routes for trapped persons through an LED indicator sign, voice broadcast, or the like. More descriptions regarding the fire risk region may be found in FIG. 2 and the related descriptions thereof.

In some embodiments, the emergency supervision object platform 150 may further include a wireless network. The wireless network is configured to achieve wireless communication connection between devices or platforms. In some embodiments, the wireless network includes Wi-Fi, 5G, LoRa, Bluetooth, etc.

In embodiments of the present disclosure, the system 100 can automate and intelligently handle emergency evacuation in the high-rise buildings during fire incidents. With real-time multimodal monitoring, early identification of the fire risk region, dynamic generation of the safety region, and precise deployment and guidance of the emergency robot, the system 100 significantly improves efficiency and safety of personnel evacuation in the high-rise buildings during fire incidents, reducing casualties. Meanwhile, the use of the IoT large model makes data fusion, analysis, and decision-making more efficient and comprehensive.

FIG. 2 is a flowchart illustrating an exemplary emergency evacuation method for smart city high-rise building fire based on an IoT large model according to some embodiments of the present disclosure. As shown in FIG. 2, a process 200 includes the following operations. In some embodiments, the process 200 may be executed by the emergency supervision and management platform.

In 210, monitoring an environmental parameter of each of one or more geographic regions through a multimodal sensor group.

The geographic regions refer to units divided inside a building. For example, the geographic regions may include a floor, a room, a corridor, a fire compartment, or a specific space. Corresponding sensors may be deployed in one geographic region. For example, a smoke sensor may be deployed in the corridor.

The environmental parameter refers to a parameter monitored and collected by a sensor for describing an environmental state. For example, the environmental parameter may include at least one of a temperature, a smoke concentration, and an oxygen concentration. The temperature, the smoke concentration, and the oxygen concentration may be monitored and collected by a temperature sensor, a smoke sensor, and an oxygen sensor, respectively. As another example, the environmental parameter may further include a wind force and a wind direction. The wind force and the wind direction may be monitored and collected by a miniature wind speed and direction sensor.

In some embodiments, the multimodal sensor group may continuously monitor and collect the environmental parameter of each of the one or more geographic regions. In some embodiments, the multimodal sensor group may periodically monitor and collect the environmental parameter of each of the one or more geographic regions based on a preset collection cycle. The preset collection cycle may be set manually or set by the system. For example, the preset collection cycle may be set to 30 minutes.

In some embodiments, the multimodal sensor group may control, based on an instruction sent by the processor, the smoke sensor, the temperature sensor, the oxygen sensor, the thermal imaging sensor, the toxic gas sensor, and the miniature wind speed and direction sensor to collect and upload monitoring data at a monitoring frequency; mark a sensor that does not upload the monitoring data among the smoke sensor, the temperature sensor, the oxygen sensor, the thermal imaging sensor, the toxic gas sensor, and the miniature wind speed and direction sensor.

In some embodiments, the processor may send the instruction to the multimodal sensor group based on a monitoring requirement to adjust a frequency at which the sensor collects and uploads the monitoring data. For example, in response to the smoke sensor detecting abnormal data (e.g., a smoke concentration is higher than a preset concentration threshold), the processor may increase the frequency of collecting and uploading the monitoring data. In some embodiments, the processor may assign a monitoring frequency based on a type of the sensor. For example, a monitoring frequency of the temperature sensor may be higher than a monitoring frequency of the oxygen sensor. In some embodiments, a quantity of the sensors may be negatively correlated with the frequency at which the sensor collects and uploads the monitoring data. For example, in response to the quantity of the sensors deployed in the one or more geographic regions being higher than a preset quantity threshold, the processor may decrease the frequency at which the sensor collects and uploads the monitoring data. More descriptions regarding the multimodal sensor group may be found in FIG. 1 and the related descriptions thereof.

In some embodiments, in response to a heartbeat packet of the sensor or the monitoring data failing to be uploaded, the processor may mark a status of the sensor as “offline” or “faulty” in a sensor status table. The sensor status table is stored in a database. The emergency supervision and management platform may send the “offline” or “faulty” status of the sensor to the emergency supervision object platform for visual presentation, facilitating maintenance personnel to repair and replace the sensor.

The embodiments of the present disclosure ensure timeliness and accuracy of the collected monitoring data by controlling different sensors to collect and upload the monitoring data at different monitoring frequencies and quickly adjusting the monitoring frequency in response to an abnormality. The embodiments of the present disclosure improve the reliability and robustness of the system by marking the sensor that fails to upload the monitoring data, timely discover and repair a fault point, and avoid information blind spots and decision-making errors caused by sensor failure, thereby ensuring coverage and connectivity of a monitoring network.

In 220, identifying a fire risk region from the one or more geographic regions based on the environmental parameter and BIM data through a processor.

The BIM data refers to a data set that integrates various types of information throughout a full life cycle of a construction project based on a three-dimensional model. For example, the BIM data may include a geometric form (e.g., a dimension, a position, and a shape), a physical property (e.g., a material, and energy consumption), or the like.

The fire risk region refers to a geographic region where the environmental parameter becomes abnormal. For example, the temperature and/or the smoke concentration of the geographic region rises sharply within a short period of time.

In some embodiments, the emergency supervision and management platform may identify the fire risk region based on the environmental parameter of each of the one or more geographic regions. For example, in response to the environmental parameter of each of the one or more geographic regions satisfying a first preset condition, the emergency supervision and management platform may identify the geographic region as the fire risk region. Merely by way of example, the first preset condition may include at least one of the temperature being higher than a preset temperature threshold, the smoke concentration being higher than a preset smoke concentration threshold, and the oxygen concentration being lower than a preset oxygen concentration threshold.

In some embodiments, the emergency supervision and management platform may determine whether the geographic region is the fire risk region based on a fire confidence level of the geographic region. More descriptions may be found in FIG. 4 and the related descriptions thereof.

In 230, determining a first emergency kit and an evacuation route for evacuating from a building based on the fire risk region by retrieving a database, controlling the first emergency kit to automatically open an airtight door and release a first emergency robot, and sending an early warning notice to user terminals in the fire risk region and an adjacent geographic region.

The first emergency kit refers to an emergency kit located on and/or near the evacuation route. The first emergency robot refers to an emergency robot placed inside the first emergency kit. More descriptions regarding the emergency kit and the emergency robot may be found in FIG. 1 and the related descriptions thereof.

The adjacent geographic region refers to another geographic region that is directly adjacent and/or indirectly adjacent to the one or more geographic regions in geographic space. For example, the one or more geographic regions share a boundary or a boundary point with the adjacent geographic region. As another example, the one or more geographic regions and the adjacent geographic region have connectivity in space and are mutually reachable.

The early warning notice refers to warning information regarding a potential fire. In some embodiments, the early warning notice may include text, voice, animation, or the like.

In some embodiments, the emergency supervision and management platform may determine the first emergency kit and the evacuation route by retrieving the database based on three-dimensional coordinates of the fire risk region, a scope (e.g., a count of covered geographic regions) of the fire risk region, and three-dimensional coordinates of the user terminal.

For example, the emergency supervision and management platform may construct a first feature vector based on the three-dimensional coordinates of the fire risk region, the scope of the fire risk region, and the three-dimensional coordinates of the user terminal. The emergency supervision and management platform may retrieve in a first vector database based on the first feature vector to obtain the first emergency kit and the evacuation route.

The three-dimensional coordinates of the fire risk region and the scope of the fire risk region may be determined based on the BIM data. The three-dimensional coordinates of the user terminal may be obtained through the emergency supervision user platform. The emergency supervision user platform may obtain the three-dimensional coordinates of the user terminal through a global navigation satellite system (GNSS). The vector database refers to a database for storing, indexing, and querying vectors. The vector database enables fast similarity queries and other vector management operations on a large number of vectors. The vector database may be stored in the database.

In some embodiments, the emergency supervision and management platform may obtain three-dimensional coordinates of a reference fire risk region, a scope of the reference fire risk region, and three-dimensional coordinates of a reference user terminal based on the BIM data and simulation experiment data (e.g., simulated fire data, a distribution of simulated user terminals, three-dimensional coordinates of the simulated user terminals, etc.). The emergency supervision and management platform may construct a plurality of first reference vectors based on the three-dimensional coordinates of the reference fire risk region, the scope of the reference fire risk region, and the three-dimensional coordinates of the reference user terminal. The first reference vector has a corresponding first vector label. The first vector label may include a reference emergency kit and a reference evacuation route corresponding to a minimum simulation rescue time and/or a maximum number of evacuated persons. The emergency supervision and management platform may store the plurality of first reference vectors and the corresponding first vector labels into the first vector database. In some embodiments, the computing unit may calculate a similarity (e.g., a cosine similarity and a Euclidean distance) between the first feature vector and the plurality of first reference vectors, and determine a first vector label of a first reference vector with a highest similarity as the first emergency kit and the evacuation route.

In some embodiments, the emergency supervision and management platform may send an unlocking instruction to the emergency supervision object platform based on the evacuation route. The emergency supervision object platform sends the unlocking instruction to the first emergency kit through the wireless network, and controls the first emergency kit to automatically open the airtight door to release the first emergency robot.

In 240, controlling the first emergency robot to move along the evacuation route via a wireless network and sending a guidance signal to a user.

The guidance signal refers to an indicator light signal and/or a voice broadcast signal of the emergency robot. For example, a light emitting diode (LED) light on the emergency robot may guide the user to evacuate along the evacuation route with a specific flashing frequency or color change.

In some embodiments, the emergency supervision and management platform may send a guidance instruction to the emergency supervision object platform. The emergency supervision object platform sends the guidance instruction to the first emergency robot via the wireless network, and controls the first emergency robot to advance along the evacuation route at a preset speed. The preset speed may be determined based on factors such as a width of an evacuation passageway, a terrain complexity, and a personnel density. For example, the preset speed may be increased in a wide and flat corridor, and the preset speed may be decreased in a narrow region or a region with obstacles.

In 250, in response to presence of a fire, identifying safety regions within the building from the one or more geographic regions through the processor, and sending the safety regions to a user terminal on a designated floor via the wireless network.

The safety region refers to a geographic region where temporary refuge can be taken after a fire occurs. For example, the safety region may be a geographic region where the temperature is lower than the preset temperature threshold.

In some embodiments, the emergency supervision and management platform may identify the safety regions based on the environmental parameter of each of the one or more geographic regions. For example, in response to a determination that the environmental parameter of each of the one or more geographic regions does not satisfy the first preset condition, the emergency supervision and management platform may identify the geographic regions as the safety regions. More descriptions regarding the first preset condition may be found in the operation 220 and the related descriptions thereof.

More descriptions regarding identifying the safety regions from the one or more geographic regions may be found in FIG. 4 and the related descriptions thereof.

In 260, determining a second emergency kit and a temporary evacuation route based on a distribution of the safety regions, and controlling the second emergency kit to automatically open another airtight door and release a second emergency robot.

The distribution of the safety regions refers to a spatial distribution of the safety regions within the building. For example, the safety regions may be distributed on the same floor and/or different floors of the building.

The temporary evacuation route refers to an emergency evacuation route that is quickly planned and established to reach the safety regions when a fire occurs. In some embodiments, the temporary evacuation route may be a part of the evacuation route.

The second emergency kit refers to an emergency kit located on and/or near the temporary evacuation route. The second emergency robot refers to an emergency robot placed in the second emergency kit. In some embodiments, the first emergency kit may be the same as or different from the second emergency kit, and the first emergency robot may be the same as or different from the second emergency robot. More descriptions regarding the emergency kit and the emergency robot may be found in FIG. 1 and the related descriptions thereof.

In some embodiments, the emergency supervision and management platform may determine the second emergency kit and the temporary evacuation route based on the distribution of the safety regions and by using a path planning algorithm. The path planning algorithm may include a Dijkstra algorithm, a genetic algorithm, an ant colony optimization (ACO) algorithm, or the like. In some embodiments, the determination of the second emergency kit and the temporary evacuation route is similar to the determination of the first emergency kit and the evacuation route. More descriptions may be found in the operation 230 and the related descriptions thereof.

The process of controlling the second emergency kit to automatically open another airtight door and release the second emergency robot is similar to the process of controlling the first emergency kit to automatically open the airtight door and release the first emergency robot. More descriptions may be found in the operation 230 and the related descriptions thereof.

In 270, controlling the second emergency robot to move toward a nearest safety region along the temporary evacuation route via the wireless network, and sending the guidance signal to the user.

In some embodiments, the emergency supervision and management platform may send the guidance instruction to the emergency supervision object platform. The emergency supervision object platform sends the guidance instruction to the second emergency robot via the wireless network and controls the second emergency robot to travel to the nearest safety region along the temporary evacuation route at a preset speed. More descriptions regarding the preset speed and the guidance signal may be found in the operation 240 and the related descriptions thereof.

In some embodiments, the adjacent geographic region may include a potential risk region, and the process 200 may further include operation 280.

In 280, estimating a potential risk region based on a location of the fire risk region, a wind direction, and an operation condition of a ventilation system.

The potential risk region refers to a region that has not been affected by a fire yet but has a possibility of fire spread. For example, the fire is located on a third floor of the building. However, due to the wind direction and the wind speed, a geographic region on a fourth floor may be affected by the fire. The geographic region on the fourth floor is the potential risk region.

The location of the fire risk region refers to a spatial location of the geographic region where the fire occurs within the building. In some embodiments, the location of the fire risk region may be an ignition point or a center of the fire risk region. For example, the location of the fire risk region may be three-dimensional coordinates of the ignition point or three-dimensional coordinates of the center of the fire risk region.

In some embodiments, the miniature wind speed and direction sensor may collect the wind speed in real time and upload the wind speed collected in real time to the emergency supervision and management platform via an emergency supervision sensor network platform. The emergency supervision and management platform may combine the BIM data and design data of the ventilation system to predict a spread direction and/or a spread path of smoke and/or heat based on the wind speed. The design data of the ventilation system may include an air volume, the wind speed and a flow velocity, a pipe size and direction, air outlet arrangement, or the like.

The operation condition of the ventilation system refers to an operation state, performance, or the like, of the ventilation system during operation. For example, the operation condition of the ventilation system may include an operation state (e.g., start or stop) and performance data (e.g., the wind speed, an air supply volume, energy consumption, or the like).

In some embodiments, the emergency supervision and management platform may estimate the potential risk region based on the location of the fire risk region, the wind direction, and the operation condition of the ventilation system by using a fire spread model. More descriptions may be found in FIG. 3 and the related descriptions thereof.

The embodiments of the present disclosure can identify the potential risk region based on the location of the fire risk region, the wind direction, and the operation condition of the ventilation system, so that an emergency response is changed from passive firefighting to active prevention and early intervention, providing a basis for releasing the emergency robot, thereby gaining more preparation time for personnel evacuation and subsequent rescue.

The embodiments of the present disclosure can achieve automatic and intelligent processing of emergency evacuation in the high-rise buildings during fire incidents. With real-time monitoring by the multimodal sensor group, early identification of the fire risk region, identification of the safety regions, and precise deployment and guidance of the emergency robot, the present disclosure can significantly improve the efficiency and safety of personnel evacuation in the high-rise buildings during fire incidents, reduce casualties, and compensate for defects of traditional manual evacuation such as instruction lag, incomplete information, and insufficient guidance capability, providing a strong guarantee for the safe operation of smart city.

FIG. 3 is a schematic structural diagram illustrating a fire spread model according to some embodiments of the present disclosure.

In some embodiments, as shown in FIG. 3, the emergency supervision and management platform may construct a prediction map 350 based on a location 310 of a fire risk region, a wind direction 320, an operation condition 330 of a ventilation system, and BIM data 340. The prediction map 350 may be a data structure composed of nodes 351 and edges 352. The edges 352 connect the nodes 351. The nodes 351 and the edges 352 have node attributes and edge attributes, respectively.

The nodes 351 may include a plurality of geographic regions. The node attributes may include whether a fire occurs (e.g., 0 indicates no fire, and 1 indicates a fire), an environmental parameter (e.g., a temperature, a smoke concentration, and oxygen concentration), and structural data (e.g., a length, a width, an outline, a floor height, a wall type, or the like). The edges 352 are used to characterize connections between the plurality of geographic regions. The edge attributes may include a distance, the wind speed, and the wind direction. In some embodiments, the wind direction is a direction of the edge 352. The node 351 may have an outgoing edge and/or an incoming edge. The incoming edge refers to an edge pointing to the node 351, and the outgoing edge refers to an edge starting from the node 351 and pointing to another node 351.

In some embodiments, an input of a fire spread model 360 is the prediction map 350, and an output of the fire spread model 360 is a potential risk region 370. In some embodiments, the fire spread model 360 may be obtained through training based on at least one set of training samples and corresponding labels. In some embodiments, the training samples may be constructed based on historical data or experimental data. The historical data or the experimental data may be obtained from a database. The training samples may include at least one set of sample prediction maps of a sample building. The labels may be the potential risk region of the sample building. In some embodiments, the labels may be determined and annotated based on historical fire data or experimental data of the sample building. For example, under conditions similar to the sample prediction map, the emergency supervision and management platform may mark the node 351 corresponding to the geographic region affected by a fire in the historical fire data or the experimental data of the sample building as the potential risk region.

During training, the training samples are input into an initial fire spread model. A loss function is constructed based on an output of an initial fire spread model and the labels. Parameters of the initial fire spread model are iteratively updated (e.g., gradient descent) based on the loss function until a preset training condition is satisfied, and the training ends. A trained fire spread model is obtained, and the trained fire spread model is used as the fire spread model 360. The preset training condition may include, but is not limited to, convergence of the loss function, a training cycle reaching a threshold, or the like.

More descriptions regarding the location 310 of the fire risk region, the wind direction 320, the operation condition 330 of the ventilation system, the BIM 340, and the potential risk region 370 may be found in FIG. 2 and the related descriptions thereof.

The embodiments of the present disclosure construct the prediction map based on the location of the fire risk region, the wind direction, and the operation condition of the ventilation system, and estimate the potential risk region using the trained fire spread model, so that a risk region where a fire may occur can be more accurately estimated based on actual situations, thereby reducing manpower costs and resource waste required for manual evaluation.

FIG. 4 is a flowchart illustrating an exemplary method for determining a fire risk region according to some embodiments of the present disclosure. As shown in FIG. 4, a process 400 includes the following operations. In some embodiments, the process 400 may be performed by the emergency supervision and management platform.

In 410, for one of a plurality of geographic regions, collecting and analyzing, through a processor, a rate of change of an environmental parameter of the geographic region and a rate of change of the environmental parameter of an adjacent geographic region.

The rate of change of the environmental parameter refers to a change amount of the environmental parameter per unit time. For example, a rate of change of temperature may be characterized as: (current temperature-last collected temperature)/time interval.

In some embodiments, the processor continuously collects the environmental parameter of each of the one or more geographic regions and the adjacent geographic region, calculates the change amount of the environmental parameter of each of the one or more geographic regions and the adjacent geographic region per unit time. In some embodiments, the processor may periodically collect the environmental parameter of each of the one or more geographic regions and the adjacent geographic region based on a preset collection cycle, calculate the change amount of the environmental parameter of each of the one or more geographic regions and the adjacent geographic region per unit time. In some embodiments, the processor may set the preset collection cycle as the unit time. For example, the preset collection cycle is set to 1 hour, and the unit time is 1 hour.

In 420, determining a fire confidence level of the geographic region based on the rate of change of the environmental parameter of the geographic region and the rate of change of the environmental parameter of the adjacent geographic region.

The fire confidence level is used to characterize an abnormality degree of the environmental parameter of the geographic region. In some embodiments, the fire confidence level may be represented by a dimensionless numerical value.

In some embodiments, the emergency supervision and management platform may determine a regional confidence level of the geographic region based on the rate of change of the environmental parameter of the geographic region. The regional confidence level refers to a baseline risk degree of a fire occurring in the geographic region. The regional confidence level may be represented by a dimensionless numerical value.

The emergency supervision and management platform may determine the fire confidence level of the geographic region based on a relationship that the fire confidence level of the geographic region is positively correlated with the regional confidence level of the geographic region and a regional confidence level of the adjacent geographic region.

In some embodiments, the regional confidence level may be determined by formula (1):

$$α = {A}_{1} \times {ω}_{11} + {A}_{2} \times {ω}_{12} - {A}_{3} \times {ω}_{13} \qquad ( 1 )$$

wherein α denotes the regional confidence level, A₁ denotes the rate of change of temperature, ω₁₁ denotes a temperature weight, A₂ denotes a rate of change of smoke concentration, ω₁₂ denotes a smoke concentration weight, A₃ denotes a rate of change of oxygen concentration, and (13 denotes an oxygen concentration weight. ω₁₁, ω₁₂ and ω₁₃ may be set based on experience or set by the system.

The fire confidence level may be determined by formula (2):

$$β = {α}_{0} + \sum ( {α}_{1} \times {ε}_{1} + {α}_{2} \times {ε}_{2} … + {α}_{n} \times {ε}_{n} ) \qquad ( 2 )$$

wherein β denotes the fire confidence level of the geographic region, α₀ denotes the regional confidence level of the geographic region, αₙ denotes a regional confidence level of an nth adjacent geographic region, εₙ denotes an association degree between the geographic region and the nth adjacent geographic region, and n is a positive integer greater than or equal to 1. The association degree ε may be determined based on a distance d between the geographic region and the adjacent geographic region. For example, the larger the distance d, the smaller the association degree. The association degree may be represented by a dimensionless numerical value. For example, a value of the association degree may be between 0 and 1.

Two cases are known: the fire confidence level is greater than a confidence threshold, and the fire confidence level is less than or equal to the confidence threshold.

In 430, in response to the fire confidence level being greater than a confidence threshold, determining the geographic region as a fire risk region. Different geographic regions have different confidence thresholds.

In some embodiments, the confidence threshold of the geographic region may be represented by a dimensionless numerical value. The emergency supervision and management platform may obtain gas usage information, historical temperature information, alarm information, a type of the geographic region, or the like, from the database.

The gas usage information may include historical gas consumption. The historical temperature information may include a temperature extreme value. The alarm information may include a historical count of false alarms and a total count of alarms. The type of the geographic region may include an office, a corridor, a kitchen, a computer room, or the like. Geographic regions of the same type may constitute a first region cluster. The confidence threshold of the geographic region may be determined by formula (3):

$${β}_{t h}^{i} = \frac{{T}_{e x t}^{i}}{{T}_{a v g}} \times \frac{{V}_{a v g}^{i}}{{V}_{a v g}} \times \frac{e r {r}_{i}}{{war}_{total}} \qquad ( 3 )$$

wherein

$${β}_{t h}^{i}$$

denotes a confidence threshold of an ith geographic region,

$${T}_{e x t}^{i}$$

temperature extreme value of the ith geographic region, T_{avg} denotes a mean of temperature extreme values of a first region cluster to which the ith geographic region belongs,

$${V}_{a v g}^{i}$$

denotes a mean of historical gas consumption of the ith geographic region, V_{avg} denotes a mean of historical gas consumption of the first region cluster to which the ith geographic region belongs, errᵢ denotes a historical count of false alarms of the ith geographic region, warₜₒₜₐₗ denotes a total count of alarms of the first region cluster to which the ith geographic region belongs, and i is a positive integer greater than or equal to 1. When

$${V}_{a v g}^{i}$$

and/or errᵢ is 0,

$${β}_{t h}^{i} = \frac{{T}_{e x t}^{i}}{{T}_{a v g}}$$

is satisfied.

In some embodiments, the emergency supervision and management platform may identify a safety region based on environmental parameters of a plurality of geographic regions; update the safety region to the fire risk region based on the rate of change of the environmental parameter of the safety region.

In some embodiments, the emergency supervision and management platform may continuously analyze environmental parameters (e.g., the temperature, the smoke concentration, and the oxygen concentration) of the plurality of geographic regions, and predict, based on a prediction map, a diffusion path of smoke and/or heat using a Gaussian plume model or computational fluid dynamics (CFD). The Gaussian plume model and the CFD may be stored in a data processing model library. The emergency supervision and management platform may determine the geographic region that is not on the diffusion path of smoke and/or heat and has the rate of change of environmental parameters less than a first change rate threshold based on the environmental parameters of the plurality of geographic regions and the diffusion path of the smoke and/or heat, and determine the geographic region as the safety region. The first change rate threshold may be set based on experience or set by the system.

In some embodiments, a computing unit may calculate the fire confidence level of the safety region based on the rate of change of the environmental parameter of the safety region. In response to the fire confidence level of the safety region being greater than the confidence threshold, the emergency supervision and management platform may update the safety region as the fire risk region. More descriptions regarding the fire risk region and the safety region may be found in FIG. 2 and the related descriptions thereof. More descriptions regarding the prediction map may be found in FIG. 3 and the related descriptions thereof. More descriptions regarding the fire confidence level may be found in the operation 420 and the related descriptions thereof.

In some embodiments, the emergency supervision and management platform may dynamically evaluate, through the processor, a real-time survival index of each of the plurality of geographic regions; identify the safety region based on the real-time survival index of each of the plurality of geographic regions; analyze a rate of change of the real-time survival index through the processor, determine a target time based on the rate of change of the real-time survival index, and send the early warning notice to a user terminal in the safety region at the target time.

The real-time survival index (RSI) refers to an index that characterizes a degree to which a geographic region is suitable for survival of the trapped persons. In some embodiments, the RSI may be a score between 0 and 100. The higher the score, the higher the safety of the geographic region, and the greater the suitability for survival of the trapped persons.

In some embodiments, the processor or the computing unit may calculate the RSI of the geographic region in real time based on formula (4):

$$R S {I}_{i} = ( {O}_{i} \times {ω}_{21} - {T}_{i} \times {ω}_{22} - {C}_{i} \times {ω}_{23} ) \times ( 1 - μ ) \qquad ( 4 )$$

wherein RSIᵢ denotes an RSI of the ith geographic region, Tᵢ denotes a temperature of the ith geographic region, Cᵢ denotes a smoke concentration of the ith geographic region, Oᵢ denotes an oxygen concentration of the ith geographic region, ω₂₁ denotes the oxygen concentration weight, ω₂₂ denotes the temperature weight, ω₂₃ denotes the smoke concentration weight, and μ denotes a penalty factor. The penalty factor is used to perform punitive reduction on the RSᵢ. In response to a concentration of a toxic gas (e.g., CO/CO2) in a geographic region rising or the geographic region being located on the diffusion path of smoke, the emergency supervision and management platform may reduce the RSI of the geographic region. ω₂₁, ω₂₂, ω₂₃, and μ may be set based on experience or set by the system.

In some embodiments, two scenarios are known: the RSI is greater than a preset RSI threshold, and the RSI is less than or equal to the preset RSI threshold. For one of the plurality of geographic regions, in response to the RSI of the geographic region being greater than the preset RSI threshold, the emergency supervision and management platform may determine the geographic region as the safety region. The preset RSI threshold may be set based on experience or set by the system. For example, the preset RSI threshold may be set to 80.

The rate of change of the RSI refers to a change amount of the RSI per unit time. For example, the rate of change of the RSI may be characterized as: (current RSI-previously collected RSI)/time interval.

In some embodiments, the processor may continuously collect the RSI of the geographic region and calculate the change amount of the RSI of the geographic region per unit time. In some embodiments, the processor may periodically collect the RSI of the geographic region and calculate the change amount of the RSI of the geographic region per unit time based on a preset collection cycle. In some embodiments, the processor may set the preset collection cycle as the unit time. For example, the preset collection cycle is set to 1 hour, and the unit time is 1 hour.

The target time refers to a time when the RSI of the geographic region decreases to the preset RSI threshold. In some embodiments, the processor may determine the target time based on a difference between a current time and a safety time of the safety region. The safety time of the safety region may be determined based on the rate of change of the RSI of the safety region. More descriptions regarding the safety time may be found below and the related descriptions thereof.

In some embodiments, the emergency supervision and management platform may estimate, based on the rate of change of the real-time survival index of the safety region, the safety time of the safety region; predict a change trend of the real-time survival index of the safety region in a future time period. The user terminal in the safety region is configured to display the real-time survival index and a remaining safety time of the safety region.

The safety time refers to a duration for which the safety region maintains a safety state. For example, if a time period from the time when a geographic region is identified as a safety region to the time when the geographic region becomes a potential risk region or a fire risk region is 30 minutes, the time period is the safety time of the geographic region.

In some embodiments, the emergency supervision and management platform may estimate the safety time of the safety region based on the RSI of the safety region, the rate of change of the RSI of the safety region, and the preset RSI threshold. For example, the safety time may be characterized as: (RSI-preset RSI threshold)/rate of change of the RSI.

In some embodiments, the emergency supervision and management platform may predict the change trend (e.g., decreasing or fluctuating around a certain value) of the RSI of the safety region in the future time period through exponential smoothing or a machine learning model. The machine learning model may include a long short-term memory (LSTM) model, a Transformer, a random forest, or the like. The future time period may be set based on experience or set by the system. For example, the future time period may be set to a next 1 hour from the current time.

In some embodiments, the emergency supervision and management platform may send the RSI and the remaining safety time of the safety region to the emergency supervision user platform through the emergency supervision service platform. The emergency supervision user platform presents the RSI and the remaining safety time of the safety region to a user through the user terminal.

The embodiments of the present disclosure achieve transparency and personalization of evacuation information by intuitively presenting the estimated safety time on the user terminal. Trapped persons not only know the safety of the current geographic region but also clearly understand the remaining safety time of the geographic region. Accordingly, self-rescue capabilities of the trapped persons can be enhanced, and the evacuation efficiency can be optimized.

The embodiments of the present disclosure provide a quantitative, intuitive, and comprehensive safety evaluation standard through the RSI, making identification of the safety regions more scientific and accurate. By analyzing the rate of change of the RSI and issuing an early warning in advance, the system can provide the trapped persons with valuable “remaining safety time”, achieving predictive evacuation and avoiding hasty evacuation at the last moment, thereby greatly improving the evacuation efficiency.

The embodiments of the present disclosure achieve dynamic updating of the safety regions. The system can identify and adjust the safety regions in real time according to fire development, rather than relying on static presets. The embodiments of the present disclosure can timely update the temporary evacuation route by dynamically updating a region that is no longer safe as the fire risk region, avoiding personnel staying in the potential risk region, thereby significantly improving real-time safety protection capabilities.

In some embodiments, the emergency supervision and management platform may determine a release time of a reconnaissance robot based on a change in a quantity of the potential risk regions through the processor, and control an emergency kit of each of the potential risk regions to automatically open the airtight door and release the reconnaissance robot; determine a release time of a fire-fighting robot based on the fire confidence level of the geographic region and the fire confidence level of the adjacent geographic region through the processor, and control the emergency kit of each of the fire risk region and the adjacent geographic region to automatically open the airtight door and release the fire-fighting robot.

The change in the quantity of the potential risk regions refers to a quantity change of the potential risk region from none to some or from few to many. In some embodiments, the processor may continuously monitor and analyze the change in the quantity of the potential risk regions.

In some embodiments, in response to first occurrence of the potential risk region, the emergency supervision and management platform may determine a time at which the potential risk region occurs as the release time of the reconnaissance robot, and determine the potential risk region as a geographic region for releasing the reconnaissance robot. For example, in response to the emergency supervision and management platform first predicting that the geographic region is located on the diffusion path of smoke and/or heat based on edge attributes of a prediction map using the Gaussian plume model or CFD, the emergency supervision and management platform may determine a time at which the geographic region is predicted as the release time of the reconnaissance robot, and determine the geographic region as the geographic region for releasing the reconnaissance robot. More descriptions regarding the prediction map may be found in FIG. 3 and the related descriptions thereof.

In some embodiments, two scenarios are known: the quantity of the potential risk regions is greater than a preset quantity threshold, and the quantity of the potential risk regions is less than or equal to the preset quantity threshold, in response to the quantity of the potential risk regions increasing to be greater than the preset quantity threshold, the emergency supervision and management platform may determine a time at which the quantity of the potential risk regions being greater than the preset quantity threshold as the release time of the reconnaissance robot, and increase a quantity of the reconnaissance robot based on the quantity of potential risk regions. The preset quantity threshold may be set based on experience or set by the system. For example, the preset quantity threshold may be set to 3.

In some embodiments, the emergency supervision and management platform may determine the release time based on a rate of change of the quantity of the potential risk regions. For example, the release time may be characterized as: a baseline release time×(1−the rate of change of the quantity of the potential risk regions). The baseline release time refers to a time preset by the system for releasing the reconnaissance robot. The rate of change of the quantity of the potential risk region refers to a change amount of the quantity of the potential risk regions per unit time. For example, the rate of change of the quantity of the potential risk region may be characterized as: (current quantity of potential risk regions−previously determined quantity of potential risk regions)/time interval. When the rate of change of the quantity increases, the release time may be shortened based on the baseline release time, thereby releasing the reconnaissance robot earlier.

In some embodiments, in response to the fire confidence level of the geographic region reaching or exceeding the confidence threshold, the emergency supervision and management platform may determine a time at which the fire confidence level of the geographic region reaches or exceeds the confidence threshold as the release time of the fire-fighting robot.

The process of controlling the emergency kit in the potential risk region to automatically open the airtight door to release the reconnaissance robot, and the process of controlling the emergency kit in the fire risk region and the adjacent geographic region to automatically open the airtight door to release the fire-fighting robot are similar to the process of controlling the first emergency kit to automatically open the airtight door to release the first emergency robot. More descriptions may be found in FIG. 2 and the related descriptions thereof.

In some embodiments, the emergency supervision and management platform may further determine a release time of a guidance robot based on the RSI of the plurality of geographic regions and the rate of change of the RSI.

In some embodiments, two scenarios are known: the rate of change of the RSI is greater than a second change rate threshold, and the rate of change of the RSI is less than or equal to the second change rate threshold, the emergency supervision and management platform may determine a time at which the RSI of the geographic region decreases to the RSI threshold, and the rate of change of the RSI is greater than the second change rate threshold as the release time of the guidance robot. The second change rate threshold may be determined based on experience or set by the system. In some embodiments, in response to RSIs of at least two geographic regions of the plurality of geographic regions decreasing to the RSI threshold, the emergency supervision and management platform may sort the at least two geographic regions based on rates of change of the RSIs of the at least two geographic regions, and prioritize releasing the guidance robot to a geographic region with a largest rate of change of the RSI.

In some embodiments, for at least two geographic regions of the plurality of geographic regions, the emergency supervision and management platform may determine, in response to the RSIs of the at least two geographic regions satisfying a preset similarity condition, a release sequence of the guidance robot in the at least two geographic regions; release the guidance robot to the at least two geographic regions based on the release sequence.

The preset similarity condition refers to a preset condition for determining the similarity between the plurality of geographic regions based on the RSI. In some embodiments, the emergency supervision and management platform may determine the preset similarity condition based on a clustering interval and a clustering step size. The clustering interval is an interval between 0 and the preset RSI threshold (i.e., [0, the preset RSI threshold]). The clustering step size may be set based on experience or set by the system. The emergency supervision and management platform may divide the clustering interval into a plurality of clustering sub-intervals based on the clustering step size, and set the preset similarity condition as that the RSI of the geographic region belongs to the same clustering sub-interval. The emergency supervision and management platform may classify at least one geographic region satisfying the preset similarity condition into a second region cluster. For example, assuming that the preset RSI threshold is 80 and the clustering step size is 20, the clustering interval is [0, 80], and the clustering sub-intervals are {[0, 20], [20, 40], [40, 60], [60, 80]}. The emergency supervision and management platform may classify the geographic regions into 4 second region clusters based on the clustering sub-intervals.

In some embodiments, in response to the RSIs of the at least two geographic regions satisfying the preset similarity condition, the emergency supervision and management platform may determine the release sequence of the guidance robot for the at least two geographic regions based on quantities of user terminals in the at least two geographic regions, and release the guidance robot to the at least two geographic regions based on the release sequence. For example, the emergency supervision and management platform may obtain the quantities of the user terminals in the at least two geographic regions from the emergency supervision user platform through the emergency supervision service platform, sort the at least two geographic regions based on the quantities of the user terminals in the at least two geographic regions, and prioritize releasing the guidance robot to the geographic region with the largest quantity of user terminals. In some embodiments, the emergency supervision and management platform may determine the quantities of the user terminals in the at least two geographic regions based on the node attributes of the prediction map.

The process of releasing the guidance robot is similar to the process of controlling the first emergency kit to automatically open the airtight door to release the first emergency robot. More descriptions may be found in FIG. 2 and the related descriptions thereof. More descriptions regarding the prediction map may be found in FIG. 3 and the related descriptions thereof.

The embodiments of the present disclosure introduce the quantity of the user terminals in the geographic regions, thereby achieving maximization of benefits of limited rescue resources. Among the geographic regions with similar RSIs, the embodiments of the present disclosure can prioritize releasing the guidance robot to the geographic region with a larger quantity of user terminals, significantly improving the evacuation efficiency and rescue coverage, and minimizing casualties.

The embodiments of the present disclosure can align the release timing of the guidance robot with actual evacuation needs and safety conditions of personnel based on actual fire situations. The embodiments of the present disclosure combine the RSI and the rate of change of the RSI to achieve early guidance of personnel evacuation before the geographic region becomes the fire risk region, avoiding personnel congestion and panic.

The embodiments of the present disclosure achieve phased deployment of the emergency robots. Different types of the emergency robots undertake different tasks and are released precisely based on actual fire situations, thereby optimizing configuration and utilization efficiency of emergency resources, which ensures intervention of emergency robots at different stages of the fire, improves timeliness and effectiveness of initial reconnaissance and mid-stage fire-fighting.

The embodiments of the present disclosure perform collaborative analysis of the plurality of geographic regions based on the environmental parameters and the rates of change of the environmental parameters, which can greatly improve accuracy and early detection capability of fire risk identification, overcome limitations of traditional determination based on single parameter or single region, and reduce false alarms caused by temperature fluctuations or local abnormalities, making the confidence level of fire detection higher, thereby avoiding unnecessary panic and waste of emergency resources, and ensuring precision and reliability of emergency response.

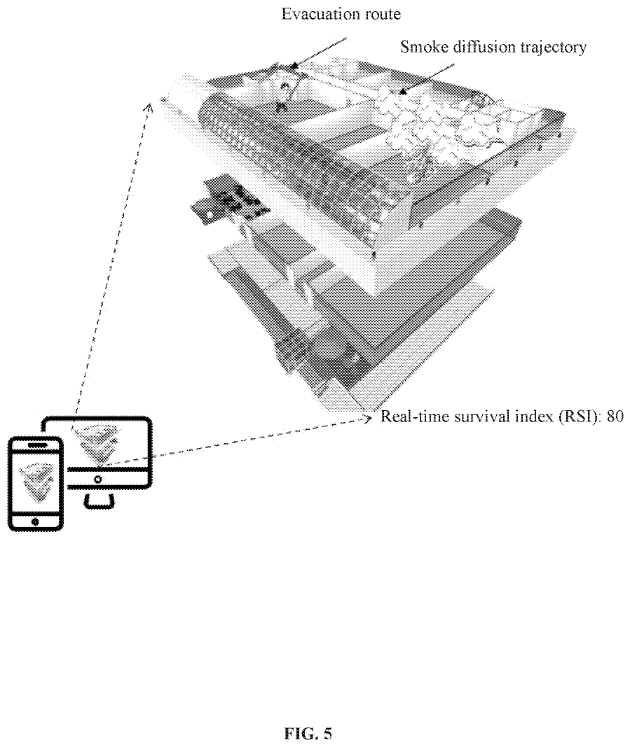

FIG. 5 is a schematic diagram illustrating an exemplary display of a three-dimensional dynamic model according to some embodiments of the present disclosure.

In some embodiments, as shown in FIG. 5, the emergency supervision and management platform may fuse the environmental parameter and the BIM data through the processor to generate the three-dimensional dynamic model of the building. The user terminal is configured to display the three-dimensional dynamic model and present the RSI of each of the one or more geographic regions, the evacuation route, and a smoke diffusion trajectory

The three-dimensional dynamic model refers to a virtual entity of a building with spatiotemporal attributes constructed through digital modeling based on the BIM data and a geographic information system (GIS). In some embodiments, the three-dimensional dynamic model may simulate dynamic processes such as crowd evacuation. For example, the three-dimensional dynamic model may be configured to dynamically display spread trajectories and speeds of flame, smoke, and heat.

In some embodiments, the emergency supervision and management platform may align the environmental parameter with the BIM data in temporal and spatial dimensions, and generate the three-dimensional dynamic model of the building through dynamic model construction, a simulation engine (e.g., Unity 3D and Unreal Engine), or the like. For example, the emergency supervision and management platform may map the environmental parameter to corresponding three-dimensional coordinate locations of the building model, and bind the environmental parameter to geometric elements such as building facades and roofs and BIM attributes (e.g., material thermal conductivity) to generate the three-dimensional dynamic model through dynamic model construction, the simulation engine, or the like.

In some embodiments, the emergency supervision and management platform may determine, in response to a change in the wind direction and the wind speed, a smoke diffusion direction and a smoke diffusion speed; dynamically adjust the safety regions and the temporary evacuation route based on the smoke diffusion direction and the smoke diffusion speed. The user terminal is configured to display the RSI of each of the one or more geographic regions by a color and a numerical value.

In some embodiments, the emergency supervision and management platform may continuously obtain the wind direction and the wind speed collected by a miniature wind speed and direction sensor from a multimodal sensor group through the emergency supervision sensor network platform. In response to a change in the wind direction and the wind speed, the emergency supervision and management platform may determine the smoke diffusion direction and the smoke diffusion speed based on the edge attributes of the prediction map using a Gaussian plume model or CFD.

In some embodiments, the emergency supervision and management platform may obtain, based on the smoke diffusion direction and the smoke diffusion speed, an updated prediction map by updating the edge attributes of the prediction map, and input the updated prediction map into a fire spread model to determine a potential risk region. The emergency supervision and management platform may identify the safety regions from the geographic regions excluding the fire risk region and the potential risk region to obtain adjusted safety regions, and determine an adjusted temporary evacuation route based on a distribution of the adjusted safety regions.

More descriptions regarding the process of obtaining the adjusted safety regions may be found in the operation 250 and the related descriptions thereof. More descriptions regarding the process of determining the adjusted temporary evacuation route may be found in the operation 260 and the related descriptions thereof. More descriptions regarding the prediction map may be found in FIG. 3 and the related descriptions thereof.

In some embodiments, the RSI of the geographic region may be displayed in a manner combining a color (e.g., green, yellow, and red) and a numerical value. For example, green indicates safety (RSI>80), yellow indicates medium risk (40≤RSI≤80), and red indicates high risk (RSI<40). When the RSI changes, the color and the numerical value of the RSI are updated in real time.

The embodiments of the present disclosure achieve dynamic adaptive adjustment of fire spread prediction. By monitoring the change in the wind direction and the wind speed in real time, the system can accurately predict the change in the diffusion trajectory of smoke and/or heat, thereby achieving real-time and dynamic adjustment of the safety regions and the temporary evacuation route and preventing trapped persons from entering risk regions. Display of the RSI color and numerical value on the user terminal enhances intuitiveness of information and timeliness of decision-making.

The embodiments of the present disclosure provide comprehensive, intuitive, and real-time visualization capability of the fire scene. By fusing the BIM data with sensor data (e.g., the environmental parameters) to generate the three-dimensional dynamic model, the user can see real-time spread of flame and smoke, the RSI heat map of each geographic region, and the evacuation route, thereby significantly improving understanding of the fire situation by the trapped persons, helping the trapped persons quickly make correct evacuation decisions, and greatly improving decision-making efficiency and accuracy of an emergency command center.

The foregoing descriptions are merely examples for illustrating the basic concepts. Obviously, for those skilled in the art, the foregoing detailed disclosure is merely an example and does not constitute a limitation on the present disclosure. Although not explicitly stated herein, those skilled in the art may make various modifications, improvements, and amendments to the present disclosure. Such modifications, improvements, and amendments are suggested according to some embodiments of the present disclosure, so such modifications, improvements, and amendments still fall within the spirit and scope of the exemplary embodiments of the present disclosure.

What is claimed is:

1. An emergency evacuation system for smart city high-rise building fire based on an Internet of Things (IoT) large model, comprising an emergency supervision and management platform, wherein the emergency supervision and management platform includes a processor and a database; and the emergency supervision and management platform is configured to:
monitor an environmental parameter of each of one or more geographic regions through a multimodal sensor group, wherein the multimodal sensor group includes at least one of a smoke sensor, a temperature sensor, and an oxygen sensor;
identify a fire risk region from the one or more geographic regions based on the environmental parameter and building information modeling (BIM) data through the processor;
determine a first emergency kit and an evacuation route for evacuating from a building based on the fire risk region by retrieving the database, control the first emergency kit to automatically open an airtight door and release a first emergency robot, and send an early warning notice to user terminals in the fire risk region and an adjacent geographic region;
control the first emergency robot to move along the evacuation route via a wireless network and send a guidance signal to a user;
in response to presence of a fire, identify safety regions within the building from the one or more geographic regions through the processor, and send the safety regions to a user terminal on a designated floor via the wireless network;
determine a second emergency kit and a temporary evacuation route based on a distribution of the safety regions, and control the second emergency kit to automatically open another airtight door and release a second emergency robot; and
control the second emergency robot to move toward a nearest safety region along the temporary evacuation route via the wireless network, and send the guidance signal to the user.

2. The emergency evacuation system according to claim 1, wherein the multimodal sensor group further includes a thermal imaging sensor, a toxic gas sensor, and a miniature wind speed and direction sensor, and the multimodal sensor group is configured to:
control, based on a command sent by the processor, the smoke sensor, the temperature sensor, the oxygen sensor, the thermal imaging sensor, the toxic gas sensor, and the miniature wind speed and direction sensor to collect and upload monitoring data at a monitoring frequency; and
mark a sensor that does not upload the monitoring data among the smoke sensor, the temperature sensor, the oxygen sensor, the thermal imaging sensor, the toxic gas sensor, and the miniature wind speed and direction sensor.

3. The emergency evacuation system according to claim 1, wherein the adjacent geographic region includes a potential risk region, and the emergency supervision and management platform is further configured to:
estimate the potential risk region based on a location of the fire risk region, a wind direction, and an operation condition of a ventilation system.

4. The emergency evacuation system according to claim 1, wherein the environmental parameter includes at least one of a temperature, a smoke concentration, and an oxygen concentration, and the emergency supervision and management platform is further configured to:
for one of a plurality of geographic regions,
collect and analyze, through the processor, a rate of change of the environmental parameter of the geographic region and a rate of change of the environmental parameter of the adjacent geographic region;
determine a fire confidence level of the geographic region based on the rate of change of the environmental parameter of the geographic region and the rate of change of the environmental parameter of the adjacent geographic region; and
in response to the fire confidence level being greater than a confidence threshold, determine the geographic region as the fire risk region.

5. The emergency evacuation system according to claim 4, wherein the emergency supervision and management platform is further configured to:
identify a safety region based on environmental parameters of the plurality of geographic regions; and
update the safety region to the fire risk region based on a rate of change of the environmental parameter of the safety region.

6. The emergency evacuation system according to claim 5, wherein the emergency supervision and management platform is further configured to:
dynamically evaluate, through the processor, a real-time survival index of each of the plurality of geographic regions;
identify the safety region based on the real-time survival index of each of the plurality of geographic regions; and
analyze a rate of change of the real-time survival index through the processor, determine a target time based on the rate of change of the real-time survival index, and send the early warning notice to a user terminal in the safety region at the target time.

7. The emergency evacuation system according to claim 6, wherein the emergency supervision and management platform is further configured to:
estimate, based on the rate of change of the real-time survival index of the safety region, a safety time of the safety region; and
predict a change trend of the real-time survival index of the safety region in a future time period;
wherein the user terminal in the safety region is configured to display the real-time survival index and a remaining safety time of the safety region.

8. The emergency evacuation system according to claim 4, wherein the first emergency robot or the second emergency robot includes a reconnaissance robot and a fire-fighting robot, and the emergency supervision and management platform is further configured to:
determine a release time of the reconnaissance robot based on a change in a quantity of potential risk regions through the processor, and control an emergency kit of each of the potential risk regions to automatically open the airtight door and release the reconnaissance robot; and
determine a release time of the fire-fighting robot based on the fire confidence level of the geographic region through the processor, and control the emergency kit of each of the fire risk region and the adjacent geographic region to automatically open the airtight door and release the fire-fighting robot.

9. The emergency evacuation system according to claim 8, wherein the first emergency robot or the second emergency robot includes a guidance robot, and the emergency supervision and management platform is further configured to:
determine a release time of the guidance robot based on a real-time survival index of each of the plurality of geographic regions and a rate of change of the real-time survival index.

10. The emergency evacuation system according to claim 9, wherein the emergency supervision and management platform is further configured to:
for at least two geographic regions of the plurality of geographic regions,
in response to real-time survival indices of the at least two geographic regions satisfying a preset similarity condition, determine a release sequence of the guidance robot in the at least two geographic regions; and
release the guidance robot to the at least two geographic regions based on the release sequence.

11. The emergency evacuation system according to claim 1, wherein the emergency supervision and management platform is further configured to:
fuse the environmental parameter and the BIM data through the processor to generate a three-dimensional dynamic model of the building; wherein
the user terminal is configured to display the three-dimensional dynamic model and present a real-time survival index of each of the one or more geographic regions, the evacuation route, and a smoke diffusion trajectory.

12. The emergency evacuation system according to claim 11, wherein the emergency supervision and management platform is further configured to:
in response to a change in a wind direction and a wind speed, determine a smoke diffusion direction and a smoke diffusion speed; and
dynamically adjust the safety regions and the temporary evacuation route based on the smoke diffusion direction and the smoke diffusion speed; wherein
the user terminal is configured to display the real-time survival index of each of the one or more geographic regions by a color and a numerical value.

13. An emergency evacuation method for smart city high-rise building fire based on an Internet of Things (IoT) large model, comprising:
monitoring an environmental parameter of each of one or more geographic regions through a multimodal sensor group, wherein the multimodal sensor group includes at least one of a smoke sensor, a temperature sensor, and an oxygen sensor;
identifying a fire risk region from the one or more geographic regions based on the environmental parameter and building information modeling (BIM) data through the processor;
determining a first emergency kit and an evacuation route for evacuating from a building based on the fire risk region by retrieving the database, controlling the first emergency kit to automatically open an airtight door and release a first emergency robot, and sending an early warning notice to user terminals in the fire risk region and an adjacent geographic region;
controlling the first emergency robot to move along the evacuation route via a wireless network and send a guidance signal to a user;
in response to presence of a fire, identifying safety regions within the building from the one or more geographic regions through the processor, and sending the safety regions to a user terminal on a designated floor via the wireless network;
determining a second emergency kit and a temporary evacuation route based on a distribution of the safety region, and controlling the second emergency kit to automatically open another airtight door and release a second emergency robot; and
controlling the second emergency robot to move toward a nearest safety region along the temporary evacuation route via the wireless network, and sending the guidance signal to the user.

14. The emergency evacuation method according to claim 13, wherein the multimodal sensor group further includes a thermal imaging sensor, a toxic gas sensor, and a miniature wind speed and direction sensor; and the multimodal sensor group is configured to:
control, based on a command sent by the processor, the smoke sensor, the temperature sensor, the oxygen sensor, the thermal imaging sensor, the toxic gas sensor, and the miniature wind speed and direction sensor to collect and upload monitoring data at a monitoring frequency; and
mark a sensor that does not upload the monitoring data among the smoke sensor, the temperature sensor, the oxygen sensor, the thermal imaging sensor, the toxic gas sensor, and the miniature wind speed and direction sensor.

15. The emergency evacuation method according to claim 13, wherein the adjacent geographic region includes a potential risk region; and the method further comprises:
estimating the potential risk region based on a location of the fire risk region, a wind direction, and an operation condition of a ventilation system.

16. The emergency evacuation method according to claim 13, wherein the environmental parameter includes at least one of a temperature, a smoke concentration, and an oxygen concentration; and the identifying the fire risk region from the geographic region includes:
for one of a plurality of geographic regions,
collecting and analyzing, through the processor, a rate of change of the environmental parameter of the geographic region and a rate of change of the environmental parameter of the adjacent geographic region;
determining a fire confidence level of the geographic region based on the rate of change of the environmental parameter of the geographic region and the rate of change of the environmental parameter of the adjacent geographic region; and
in response to the fire confidence level being greater than a confidence threshold, determining the geographic region as the fire risk region.

17. The emergency evacuation method according to claim 16, further comprising:
identifying a safety region based on environmental parameters of the plurality of geographic regions;
updating the safety region to the fire risk region based on a rate of change of the environmental parameter of the safety region.

18. The emergency evacuation method according to claim 17, wherein the identifying the safety region based on the environmental parameter of the plurality of geographic regions includes:
dynamically evaluating, through the processor, a real-time survival index of each of the plurality of geographic regions;
identifying the safety region based on the real-time survival index of each of the plurality of geographic regions; and
analyzing a rate of change of the real-time survival index through the processor, determining a target time based on the rate of change of the real-time survival index, and sending the early warning notice to a user terminal in the safety region at the target time.

19. The emergency evacuation method according to claim 18, further comprising:
estimating, based on the rate of change of the real-time survival index of the safety region, a safety time of the safety region;
predicting a change trend of the real-time survival index of the safety region in a future time period;
controlling the user terminal in the safety region to display the real-time survival index and a remaining safety time of the safety region.

20. A non-transitory computer-readable storage medium, comprising computer instructions that, when read by a computer, direct the computer to execute an emergency evacuation method for smart city high-rise building fire based on an Internet of Things (IoT) large model, comprising:
monitoring an environmental parameter of each of one or more geographic regions through a multimodal sensor group, wherein the multimodal sensor group includes at least one of a smoke sensor, a temperature sensor, and an oxygen sensor;
identifying a fire risk region from the one or more geographic regions based on the environmental parameter and building information modeling (BIM) data through the processor;
determining a first emergency kit and an evacuation route for evacuating from a building based on the fire risk region by retrieving the database, controlling the first emergency kit to automatically open an airtight door and release a first emergency robot, and sending an early warning notice to user terminals in the fire risk region and an adjacent geographic region;
controlling the first emergency robot to move along the evacuation route via a wireless network and sending a guidance signal to a user;
in response to presence of a fire, identifying safety regions within the building from the one or more geographic regions through the processor, and sending the safety regions to a user terminal on a designated floor via the wireless network;
determining a second emergency kit and a temporary evacuation route based on a distribution of the safety regions, and controlling the second emergency kit to automatically open another airtight door and release a second emergency robot; and
controlling the second emergency robot to move toward a nearest safety region along the temporary evacuation route via the wireless network, and sending the guidance signal to the user.
